(19) United States
(12) Patent Application Publication
(10) Pub. No.: US 2015/0379600 A1
(43) Pub. Date: Dec. 31, 2015

(54) ORDER MANAGEMENT SYSTEM AND METHOD FOR LIMITED COUNTERPART TRANSACTIONS

(71) Applicant: OPTION WAY, Nice (FR)

(72) Inventor: Mathieu CHAUVIN, Nice (FR)

(21) Appl. No.: 14/764,523

(22) PCT Filed: Feb. 3, 2014
(86) PCT No.: PCT/IB2014/058749

§ 371 Date: Jul. 29, 2015

(30) Foreign Application Priority Data
Feb. 1, 2013 (FR) 1350896

(51) Int. Cl. G06Q 30/06

(52) U.S. Cl. CPC G06Q 30/0611

(57) ABSTRACT

The present invention provides a computer system for managing limited counterpart transaction orders for products or services, in particular with a ceiling price, comprising: —a source of information indexing the available products or services and explanatory variables for these products or services, as well as time related counterpart information for these products or services, —an automatic classification engine adapted to gather products or services by classes of counterpart evolution, from historical counterpart data, and to attribute to each class a set of explanatory variables and an evolution behavior, —a client interface for inputting orders on given products and services defined by explanatory variable values, with a limit counterpart value, —a class allocation engine for allocating an inputted order to at least one evolution class depending on the explanatory variable values of the order, and —an indicator computation engine capable of computing a success probability indicator for an input order, combining the value of the limit counterpart value of the order with data of the evolution class(es) to which it is allocated, —means for providing to said client interface computed values of said success probability indicator, and —a matching engine to match offers and counterpart offers to convert orders into transactions when counterpart offers reach counterpart limit values of orders.

### FIELD OF THE INVENTION

The present invention relates to a system to be implemented in a computerized environment for defining, recording and executing maximum price purchase orders for products or services.

### BACKGROUND OF THE INVENTION

In most common selling processes, in particular on the Internet, sellers define the prices of the goods proposed for sale (products or services), and buyers have to take into account the offer diversity, and assess the offer according to their own criteria. This analysis is both time-consuming and complex.

When dealing with products or services whose prices significantly change during the sale period, certain processes exist that allow the buyer to follow the price and be informed about potential changes. In particular, a buyer may be informed when the price reaches a predefined target value. In this specific case, the buyer is not bound to purchase the product or service but, should he want to purchase it, he needs to act quickly and to make the purchase while the cost corresponds to his expectation.

Another known system consists in grouping conditional purchase offers in a system managed by buyers. In such a system, the product or service is automatically sold to a buyer if the predefined maximum price of the conditional offer is reached.

For instance, on the stock exchange markets, limited purchase orders are well known and are widely used in transaction platforms.

Another example can be found in the travel domain: in certain sales platforms a system driven by buyers has already been implemented which aims at collecting conditional purchase offers to purchase flight tickets, hotel nights, car rentals, etc.

The Priceline company has developed such systems.

However existing conditional purchase offer systems provide very little information to help customers fix their ceiling or maximum purchase prices, making the use of such systems difficult for buyers who do not have sufficient experience or market knowledge to determine an appropriate ceiling price.

Moreover the description of the product or service being sold is most of the time unclear, which makes the definition of a ceiling price even harder.

Thus because of a lack of both information and support, many buyers define too low maximum prices leading to a failure of their offers.

The invention presented here aims at compensating part or the totally of the technical state of the art limitations.

### SUMMARY OF THE INVENTION

The present invention aims at alleviating all or part of the prior art limitations.

The invention presented here aims at providing a system having a least one of the following functionalities:
the real-time or near real-time computation and presentation of a success probability indicator intended to help buyers fixing a relevant maximum price for a product or service purchase order;
the execution of purchase orders among a list according to priorities defined in the system;
The supply of a purchase order list to sellers to facilitate the transaction order execution.

The present invention thus provides according to a first aspect a computer system for managing limited counterpart transaction orders for products or services, in particular with a ceiling price, comprising:
a source of information indexing the available products or services and explanatory variables for these products or services, as well as time related counterpart information for these products or services,
an automatic classification engine adapted to gather products or services by classes of counterpart evolution, from historical counterpart data, and to attribute to each class a set of explanatory variables and an evolution behavior,
a client interface for inputting orders on given products and services defined by explanatory variable values, with a limit counterpart value,
a class allocation engine for allocating an inputted order to at least one evolution class depending on the explanatory variable values of the order, and
an indicator computation engine capable of computing a success probability indicator for an input order, combining the value of the limit counterpart value of the order with data of the evolution class(es) to which it is allocated,
means for providing to said client interface computed values of said success probability indicator, and
a matching engine to match offers and counterpart offers to convert orders into transactions when counterpart offers reach counterpart limit values of orders.

Preferred but non-limiting aspects of this system are the following features, taken individually or in any combinations that the skilled person will consider as compatible from his general knowledge:
said indicator computation engine is capable, for a given order, of determining an initial estimated value of said success probability indicator from lookup tables containing success probability indicator values pre-determined from historical counterpart values for a number of limit counterpart values and a number of order validity time ranges, while waiting for current counterpart values from said source of information, and of computing a refined value of said success probability indicator after said current counterpart values have been received, both said initial estimated value and said refined value being successively provided to said user interface.
the system further comprises a counterpart value caching engine for recent counterpart values, and said indicator computation engine is further capable, while waiting for current counterpart values from said source of information for a given order, of checking the contents of a cache memory handled by said caching engine to check for recent counterpart values corresponding to explanatory variable values of said order, and performing said computing with these values.
said indicator computation engine is capable of computing said success probability indicator from a weighted sum of probabilities, said probabilities being based on the density of explanatory variables associated to the classes and said weights being based on a relationship between the limit counterpart value and counterpart values in a validity time range of the order, derived from the respective classes.
said weights are Boolean values corresponding to the existence or not, within the validity time range in a class, of at least one counterpart value lower or equal to the limit counterpart value of the order.
the indicator computation engine is further adapted to perform a time-dependent weighting function between an indicator value computed from historical counterpart values and an indicator value computed from recently observed real counterpart values.
said time-dependent weighting function is performed on a periodic basis during the validity period of the order.
the evolution classes include trend classes and optional volatility classes.
the user interface is adapted to receive as input a new limit value for the counterpart during the validity period of the order, and wherein the indicator computing engine is adapted to compute a new value of the indicator in response to this input.
the system further comprises priority order management device.
the priority order management device includes means for sequencing orders according to at least two criteria among information about the loyalty of the entities entering orders, information about the quantity of products or services requested in the orders, and information about counterpart limits.
the system further comprises an aggregation engine for aggregating active orders on a product or service, and communication means between the aggregator engine and the seller's platform of the given product or service in order to allow an access to these aggregated orders.
the system further comprises adjustment means for adjusting an offered counterpart for the given product or service in accordance with the values of the limit counterparts set in the aggregated orders.
said automatic classification engine comprise a K-means classification engine combined with a Correspondence Analysis (CA).

According to a second aspect, the present invention provides a computer-implemented method for managing limited counterpart transaction orders for products or services, in particular with a ceiling price, comprising the following steps:
at a server level, receiving an order from a client user interface on a given product or service, said order being defined by explanatory variable values and having a counterpart limit value,
at said server level, requesting from an external source of information current counterpart values for said given product or service,
using said explanatory variable values of the order, allocating said order to at least one among a plurality of counterpart value evolution classes, previously built from historical counterpart values, wherein each class is associated to a set of explanatory variables and defines an evolution behavior,
computing a success probability indicator value for said input order from the counterpart limit value and the allocated evolution class(es) information,
providing said success probability indicator value to said client interface for display,
performing a matching test on said order and counterpart offers to convert said order into a transactions when a counterpart offer reaches said counterpart limit value.

Preferred but non-limiting aspects of this method are the following features, taken individually or in any combinations that the skilled person will consider as compatible from his general knowledge:
said computing step comprises determining an initial estimated value of said success probability indicator from lookup tables containing success probability indicator values pre-determined from historical counterpart values for a number of limit counterpart values and a number of order validity time ranges, while waiting for current counterpart values from said source of information, and computing a refined value of said success probability indicator after said current counterpart values have been received, both said initial estimated value and said refined value being successively provided to said user interface.
the method further comprises a step of caching recent counterpart values, and wherein said computing step comprises, while waiting for current counterpart values from said source of information for a given order, checking the cached recent counterpart values corresponding to explanatory variable values of said order, and performing said computing with these values.
said computing step comprises computing said success probability indicator from a weighted sum of probabilities, said probabilities being based on the density of explanatory variables associated to the classes and said weights being based on a relationship between the limit counterpart value and counterpart values in a validity time range of the order, derived from the respective classes.
said weights are Boolean values corresponding to the existence or not, within the validity time range in a class, of at least one counterpart value lower or equal to the limit counterpart value of the order.
said computing step comprises performing a time-dependent weighting function between an indicator value computed from historical counterpart values and an indicator value computed from recently observed real counterpart values.
said time-dependent weighting function is performed on a periodic basis during the validity period of the order.
the evolution classes include trend classes and optional volatility classes.
the method further comprises:
   receiving as input at the user interface a new limit value for the counterpart during the validity period of the order, and
   computing a new value of the indicator in response to this input.
the method further comprises a step of subjecting the conversion into a transaction to a prioritization according to at least two criteria among information about the loyalty of the entities having entered active orders, information about the quantity of products or services requested in active orders, and information about counterpart limits in the active orders.

### BRIEF DESCRIPTION OF THE DRAWINGS

Other aspects, aims and advantages of the present invention will be better understood from the following detailed description of preferred embodiments, given by way of non-limiting examples and made with reference to the appended drawings in which:

FIG. 1 is a diagram of the general architecture of a system according to the invention,

FIG. 1 bis illustrates a time-ordered interaction between different components of the architecture shown in FIG. 1,

FIG. 2 shows an automatic trend classification mechanism used in the present invention,

FIG. 3 shows a group of n classes, obtained by a k-means clustering process,

FIG. 4 shows the group of the n classes, with the different densities of an explanatory variable in two classes depicted by different hatchings,

FIG. 5 shows the same group of n classes, with the different densities of two explanatory variables in different classes depicted by different hatchings (density and orientation),

FIG. 6 shows a price vs. time graph for explaining a weighting function performed in the computation of a success probability indicator,

FIG. 7 shows a database extract that contains features of several possible flights for a given journey,

FIG. 8 shows five price observations of these flights, as a function of time,

FIG. 9 shows an example of an obtained trend (class), that corresponds to the five previous price observations of these flights,

FIG. 10 shows the set explanatory variables associated to a class,

FIG. 11 shows the explanatory variables of a given flight that allow linking this flight to the class depicted in FIG. 6,

FIG. 12 shows a price observation in a given time period for a given flight,

FIG. 13 shows a trend deduced from the price observation of FIG. 12,

FIG. 14 shows a database extract of hotel rooms, with explanatory variables,

FIG. 15 shows a price observation example for three items from the FIG. 14 extract,

FIG. 16 shows the graphs of two trend classes, deduced from these observations,

FIG. 17 shows a class database extract, with a certain number of items (room type, hotel name) per class, for a given city,

FIG. 18 shows the explanatory variables selected by a buyer for a given purchase order for a given hotel,

FIG. 19 shows a recent price observation Y1 for the order corresponding to FIG. 18, and

FIG. 20 shows the trend of the recent price observation Y1 of FIG. 19, that allows identifying the S1 class.

### DETAILED DESCRIPTION PREFERRED EMBODIMENTS

### 1. Introduction

The invention is implemented in a computerized platform dedicated to provide the definition, the storage and the execution of counterpart threshold transaction orders, in particular of purchase orders at limited prices, as well as the definition of execution priorities between different purchase orders.

According to this invention, a success probability indicator SPI for an order with a given maximum price is generated and proposed to the user so as to help him/her making a decision.

Another aspect includes the presentation to third parties, in particular to sellers, of the current purchase order list for products or services, in order to facilitate the execution of a transaction for a given product or service by adjusting the selling price.

In the following description given by way of example to illustrate the invention, a system particularly well suited to purchasing and selling flight tickets will be described. This invention may however be used for other products or services in a context of price vs. time evolution.

### 2. Platform

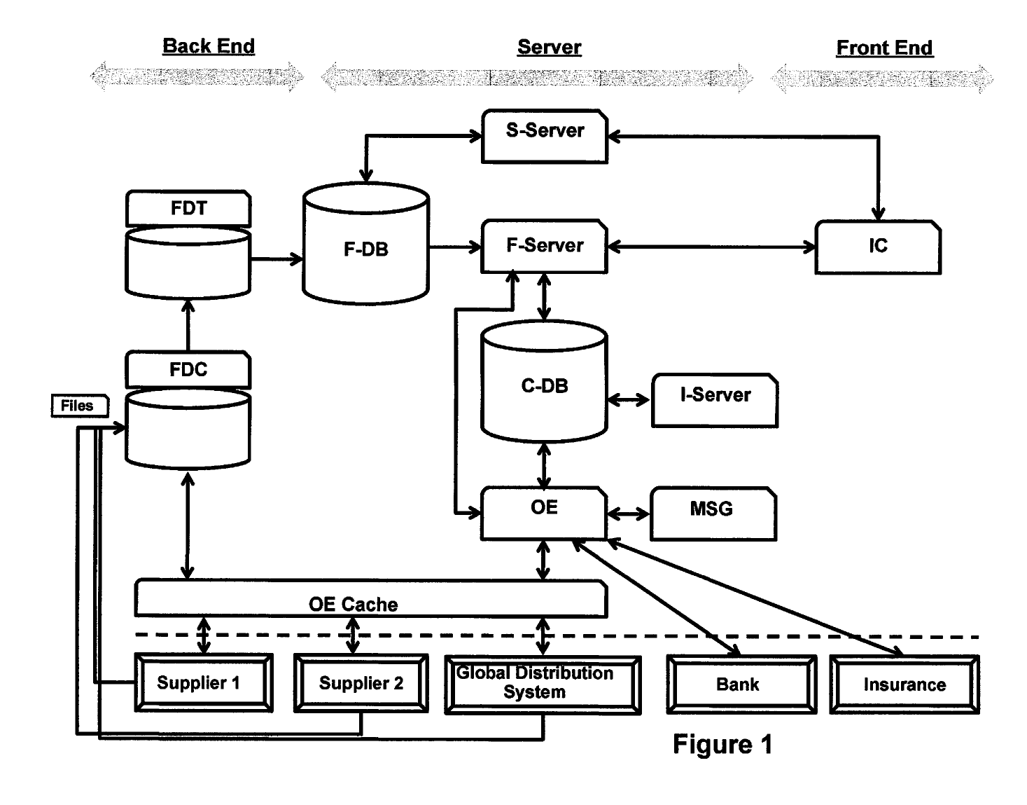

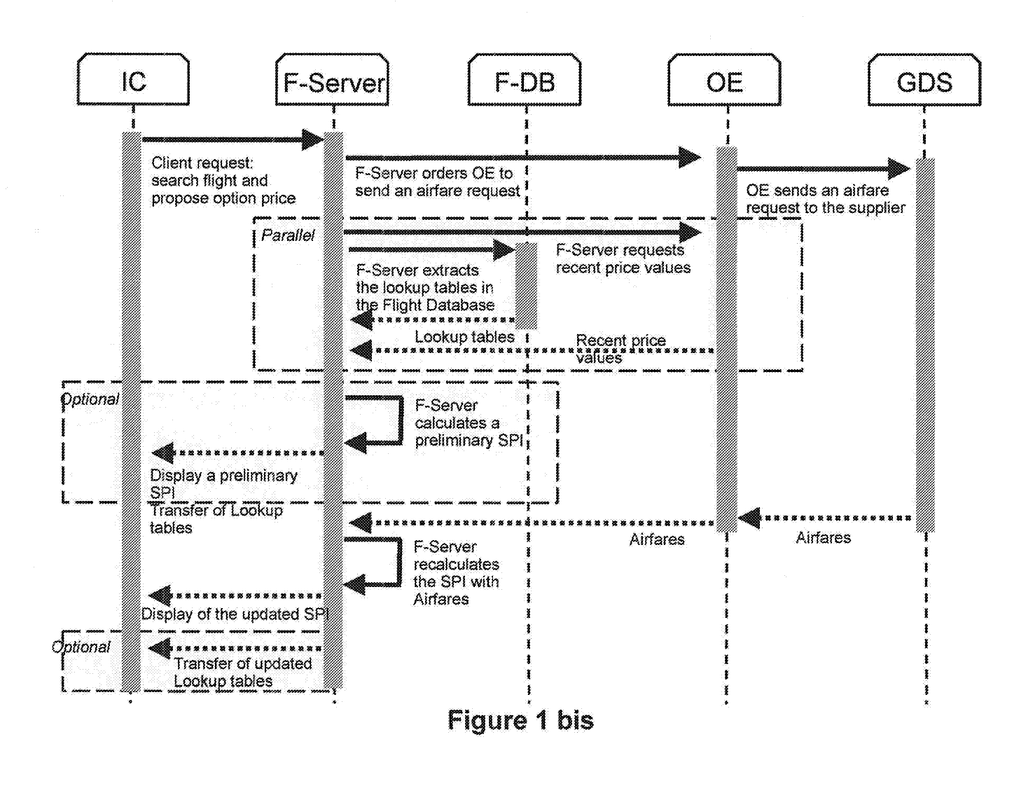

Referring first to FIG. 1, the platform is subdivided in three domains: a client or “front-end” domain, a management or “back-end” domain, and a “server” domain.

### 2.1 Front-End Domain

The client or user interface, shown as Front-End in FIG. 1, is in charge of collecting all the information from the platform and of structuring it and displaying it to the buyer.

By using a client user interface UC, usually a web interface and appropriate input devices (keyboard, mouse, etc.), the buyer is able to generate product or service purchase orders on a sales platform thanks to the following services:
a search of products or services given a set of criteria, and supply of product or service dedicated features that fit the buyer's criteria;
a buyer's selection of products or services that he/she wishes to buy;
a buyer's choice of a transaction maximum price, with the help of a success probability indicator (see below) provided by the platform. The probability indicator value is updated in real-time or near real-time and depends on the maximum price chosen by the buyer;
a payment authorization process for the seller website in case the purchase order is successful.

In the system of the invention, a buyer can generate several purchase orders and create links between them. Thanks to such links, if a purchase order is successful, the other ones are automatically canceled. Besides, the user can manually modify or cancel a purchase order whenever he wants, as long as it is not successful.

Thus, a purchase order is valid as soon as it is triggered by the buyer and until it is canceled, manually or automatically, or until the selling period of the product or service has expired.

### 2.2 Back-End Domain

This domain shown as Back-End in FIG. 1 is in charge of the execution of all computerized operations that allow converting the raw price data for a given product or service to data that may be used by the server so as to display them to the buyer. As already mentioned, it will be focus here on the specific example of flight ticket prices.

The back-end system is made of two units that widely use the software MapReduce (MR) (see e.g. http//en.wikpedia.org/wiki/MapReduce), and that are organized as follows:
A flight data collection unit (FDC) that includes a whole set of raw data of a given flight (schedule, carrier, departure airport, arrival airport, fares etc.). This unit is directly interfaced with an external raw data source. This data source may be a known global distribution system (GDS) or any other source that proposes such data. This unit handles the requests toward the source through an application programming interface (API) if it exists, or according to a method proposed by the data source. The storage of the set of raw data can be done under two forms: file storage or database storage. Unit FDC is interfaced with an option engine (OE) cache, described in the following, that is handled in the server domain. Thanks to these data, the module is able to provide to a flight data treatment unit FDT (described in the following paragraph) with the recent price data that will be used by unit FDT to estimate and update the indicators, in particular the success probability indicator SPI. This module deals with the mapping in the sense of the MapReduce environment; and
the above-mentioned flight data treatment unit (FDT), which has several functions. A first function is the reduction of the amount of data collected by the FDC in the sense of MapReduce. This reduction allows an efficient estimation, by the FDT module, of indicators that are useful to the system for computing the success probability indicator (SPI) as detailed later in this description. These indicators are, for instance, the minimum price on a given segment for a given airline, the mean price for said segment and airline, etc. A second function of the FDT module is to perform a classification (for instance, by using a K-means algorithm, further detailed in the following), so as to assign a trend class, and optionally a volatility class, to each time-related set of prices of a given flight. A third function of the FDT module is to match the trend classes and the optional volatility classes by using the flight price database and the explanatory variables assigned to these flights (these variables are detailed in the following).

These indicators computed (or “reduced”) by the environment MapReduce, as well as the class information created by the FDT module, are stored in a flight database (F-DB) that is handled by the server domain. These data are used to estimate the success probability indicator (SPI) of a given purchase order. Their availability allows ensuring a near real-time calculation of the indicator.

### 2.3 Server Domain

This domain shown as “Server” in FIG. 1 is in charge of recovering data from the back-end and sending all necessary user interface information to the buyer's client computer, of recording all the useful user data—in particular all the data entered for a purchase order—and of interfacing with both the providers (e.g., GDS) and the Bank and Insurance payment servers.

It comprises the following elements:
the above-mentioned flight database (F-DB), that is in charge of the interface with the back-end and that is used to store trend classes updated for each journey, optional volatility classes, as well as indicators computed by the FDT module. This database is interfaced with a flight server (F-Server) and optionally with the server S-Server. This database contains, in particular, indicators that allow fast calculation of the success probability indicator SPI, given both trend and volatility classes of a given flight.
the above-mentioned flight server F-Server, that is a stateless machine-based server which has several functions. Firstly, it receives requests, for example in AJAX format, from the front-end, and answers these requests by addressing certain requests to an option engine OE and a customer database C-DB, described in the following sections. This flight server interfaces with this database to store all the customer data that are used to define the selected options and to deal with the payments.
the above-mentioned customer database C-DB that is used to store all the customer information as well as their purchase orders. It also stores the payment information. The database C-DB interfaces with the flight server F-Server, with an internal server I-Server described in the following point, and with the option engine OE, also described in the following. The system has also access to this database C-DB to extract order information that aims to be presented to sellers and retailers as explained later in this description; According to a particular invention feature, the database C-DB is organized following certain priority rules defined on the platform. Such priority rules in the database allow implementing the following function: when the option engine OE compares prices proposed by sellers with selected orders, an order located at the top of an order list will be more probably executed given the fact that the number of tickets sold at a given price is expected to decrease. The parameters that may influence the list scheduling are, for instance, certain advantages offered to regular platform customers (loyalty card system), or the global amount of the order, the unit orders being valid (an order including a total cost higher than other orders for product or service purchase may be treated in priority).

For instance, assuming that there are a number of flight ticket purchase orders as follows:

order 1: 4 seats at 220 [symbol] , leading to a total amount of 880 [symbol] ,

order 2: 6 seats at 200 [symbol] , leading to a total amount of 1200 [symbol] , and that suddenly the public price decreases from 240 [symbol] to 200 [symbol] .

In this case, the platform may choose to provide in priority the order 2 which total is higher than the order 1 (1200>880). Of course, other priority rules based on other order parameters (unit price, order date, etc. . . . ) may be defined and implemented.
the above-mentioned option engine OE, capable of generating requests to the providers (in particular the global distribution systems GDS or other flight ticket retailers, in the given example) and to the payment servers. The option engine interfaces with the F-Server, the C-DB and the providers. It is initially triggered by the F-Server when a purchase order is defined by a client (cf. Success Probability Indicator computation in the following) and, once the purchase order is defined and stored, it explores the customer database C-DB to sequentially read the purchase order list it contains, and investigate whether a given order may be executed, when a current flight ticket price equals the ceiling price of this order. When the order is executed (validated purchase of the ticket), the option engine OE generates information (for instance, an electronic mail) to the buyer thanks to a link to a SMTP mail server.

Thus the option engine OE is a module of the invention that manages the purchase order lists and their execution as soon as the purchase terms are fulfilled. In practice, the option engine runs requests periodically (for instance three times a day for a flight tickets application) to provider or retailer servers to get the current prices of products or services present in the purchase order list. When a product or service current price equals or is lower than an order maximum or ceiling price for the same product or service, the transaction is automatically performed, and the bank account of the buyer is automatically debited by procedures known per se.

In a preferred embodiment of the invention, the option engine OE uses a cache that allows restricting the number of requests done to a provider (e.g. a GDS). In fact, if the selling price returned from by a request to satisfy an order is higher than the purchase prices of other orders in the list, it is useless to make this request another time for said other orders. On the other hand, if the selling price of a given order allows its execution, it is potentially useful to try to generate equivalent orders one after the other, so as to take advantage of a potential price decrease as fast as possible. Thus, the system orders the orders belonging to a same flight set for a same journey one after the other in the database C-DB. The option engine OE cache is interfaced with the flight data treatment (FDT), via the option engine itself, so that the indicators computed by the FDT module may be updated accordingly with the current prices.
the above-mentioned internal server I-Server, capable of extracting from the customer database C-DB all the information needed for the after-sales service, the supervision, the reporting and finally the management and the accounts.
the above-mentioned static server S-Server capable of generating all static information to be sent by the front-end domain. Advantageously, this server is physically distinct from the flight server F-Server for performance reasons. This server is also dedicated to generate a minimum information service in case of system service failure.

### 3. Success Probability Indicator (SPI)

### SPI Calculation Overview and Information Flow

The indicator SPI is computed and displayed in near real-time when a buyer configures his purchase order. Given the extremely large amount of data to be processed, this near real-time calculation and display is a technical problem for the skilled person and one aspect of the invention is a solution to this technical problem.

The “near real-time” performance is due to the fact that it is necessary to at least apply a request to the flight database F-DB and make the estimation in the F-server: the display to the user is not immediate because of the transmission duration of both the request and the answer; nevertheless, these durations may be extremely short.

The main steps for allowing near real-time performance are the following:
1. Historical price data over large period of time in the past are processed according to a classification algorithm described in the following, in order to reduce the data complexity and define classes. A price evolution function is attached to each of these classes. Explanatory variables, i.e. variables known a priori (such as the destination of the flight, the date of departure, etc.) are linked to all the elicited classes (labeling); these classification and labeling tasks—described in greater detail in the following—are carried out offline, i.e. with no real-time requirement.
2. For all the different labels of explanatory variables, a file of so-called lookup tables (see infra) is created (an offline task). These lookup tables which are made available in database F-DB contain pre-computed SPI values for several option durations of an order (e.g. 2 days, 7 days, 14 days, 21 days, etc.). In practice the prices are arranged in the lines (from minimal price to maximum price) and the option durations in the columns. Each element of the matrix is thus the SPI indicator calculated for the proposed price and for a given option duration.
An example of a lookup table as defined above is the following:

| | Option Durations | | | |
|---|---|---|---|---|
| Prices | 2 days | 7 days | 14 days | 21 days |
| Min_Price | SPI_2_0 | SPI_7_0 | SPI_14_0 | SPI_14_0 |
| Min_Price + D | SPI_2_1 | SPI_7_1 | SPI_14_1 | SPI_14_1 |
| Min_Price + 2D | SPI_2_2 | SPI_7_2 | SPI_14_2 | SPI_14_2 |
| Min_Price + 3D | SPI_2_3 | SPI_7_3 | SPI_14_3 | SPI_14_3 |
| . . . | . . . | . . . | . . . | . . . |
| Max_Price | SPI_2_max | SPI_7_max | SPI_14_max | SPI_21_max |

Min_Price designates the lowest considered price. If the offered price is lower than Min_Price, the SPI value is set to 0%. Max_Price designates the highest considered price. Is the offered price is higher than Max_Price, then the SPI value is set to 100%.
3. Upon request of a customer, the F-Server orders the option engine OE to launch a request for obtaining current prices from the suppliers. Typically these supplier consultation requests last a few seconds.
4. During the time the requests are processed by the suppliers, the F-Server consults the lookup tables using the explanatory variable labels. It also checks whether recent price values are contained in the cache of the OE. The F-Server then computes a preliminary success probability indicator SPI based on the lookup tables values and the recent price values, if any. Preferably, this preliminary indicator SPI is presented to the customer before the request to the supplier is answered and subsequently updated.
5. Upon answer of the suppliers, the preliminary SPI value is modified to account for present prices (cf. equations in section 7.2) and the modified indicator SPI is presented to the customer.
6. Optionally, in order to still increase the system reactivity, the relevant lookup tables (original and updated) may be transferred to the client side (front-end). With this information, indicator SPI can be updated in real-time by the client computer itself in case the customer modifies its threshold price. Of course, other types of lookup tables, for instance corresponding to similar or broader sets of explanatory variables, can be prepared and sent to the client in order to provide immediate SPI determination when certain explanatory variables are changed.

The above process is illustrated in FIG. 1bis. Indicator SPI is also available for the buyer during the whole purchase order duration validity, and its variations may be automatically transmitted to the buyer.

It can also be provided that when the indicator value SPI is too low, the platform automatically advises the buyer to purchase the product as soon as possible or to modify the criteria of his order, so as to avoid generating (and paying for) requests to the GDS that have almost no chance to succeed. There is here another advantage of computing a SPI indicator, i.e. avoiding to manage orders that have no (or almost no) chances to succeed.

### SPI Calculation Detailed Description

As explained in the preceding section, the success probability indicator SPI is computed based on allocation of one or several counterpart value evolution classes to an order, based on the explanatory variables of said order. This computation uses the following information:

1) the upstream information about the product or service, i.e. the main characteristics of a product or service selected by the user are clearly known; for instance, in the flight tickets specific case, the principal features are the carrier, the schedule of the considered flight, the flight number, and the interval between the order date and the flight date;

2) the price proposed by the seller for purchasing the product or service: this price may be the one effectively inputted by the buyer, or a price suggested by the sales platform;

3) the knowledge of the past price evolution for a similar product or service: the price history given for a long period (in months or years) is known, as well as certain statistical data such as the average price, the median price, the minimum price; this past knowledge is relevant so as to obtain a good estimation of indicator SPI, as detailed in the following;

4) the price trend of the product or service in the recent past: the recent price evolution, as for instance the price evolution over the past month for a specific flight, is also taken into account; this information allows, firstly, to calibrate a probability estimation algorithm, and secondly, to update this estimation during the purchase order validity period; even though it is not essential to the indicator calculation, this information is taken into account when available.

The indicator is assessed thanks to an algorithm designed to combine these data so as to predict as reliably as possible the success probability of a given purchase order.

This algorithm will now be explained in detail.

Firstly, given the complexity of the problem considered here, involving a huge number of variables (carriers, destinations, dates, etc.) and a large amount of data, it is necessary to simplify the problem.

This is done by clustering the data in a relevant way. This simplification is performed offline, meaning that it is done systematically and before being useful to a given buyer by the back-end, so as to make sure that the indicator is given to the buyer in near real-time.

Thus a number of price evolution classes are first created in the system. Then all price evolutions are assigned to a given class selected among the different classes.

The classes are based on an a priori knowledge of a typical price evolution, and are defined empirically. For instance, there can be created a class of strictly increasing prices as a function of time, a class of increasing then decreasing prices as a function of time, etc.

In a preferred embodiment, a low-pass filter is applied to the data (for example, by doing a sliding mean-value computation using a time width of several days). The price data vector Pi (as a function of time) may then be expressed as:

Pi=Xi+Vi

where Xi is the price evolution trend (i.e. the result of the low-pass filtering) and Vi the price volatility.

The price volatility contains the range in which the prices vary and the variation frequency for each short period (typically, several days). The processing that will be performed on this volatility Vi is described in the following.

The affectation of a given price trend to a class (for instance classes such as increasing trend, decreasing trend, increasing then decreasing trend, etc.) is a well-known problem in the classification process in machine learning.

It should be underlined here that frequently, part of the price information is missing when collecting data flights. Thus, it is important for the chosen classification to be robust to missing data.

Hence, in a preferred embodiment of the invention described in the following, it is suggested to use a K-means clustering algorithm. Nevertheless, it is important to mention that other well-known automatic classification algorithms may be used. For instance, the support vector machine algorithms (SVM), or latent class model based algorithms are particularly well suited. Besides, it is also possible to use a fuzzy logic implementation of these algorithms, according to which an element is classified in a cluster according to a given probability, the probability sum over the clusters equaling to 1.

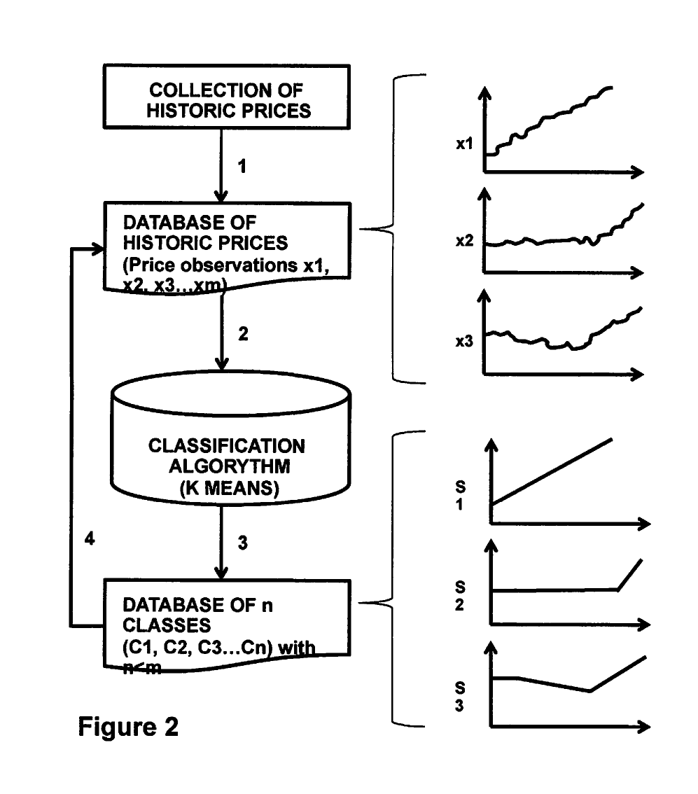

Referring to FIG. 2, the algorithm includes several steps:

a) given a set of m known observations (X1, X2, . . . , Xm), which are low-pass filtered, and where each observation is a vector of real prices, the automatic clustering, here performed by using K-means, allows, according to a well-known procedure, classifying the m observations in n sets, or classes (with n<=m), so as to minimize the sum of the distances between the vectors in a given set. This first step divides the observation space S as follows:
S={S1, S2, . . . Sn}

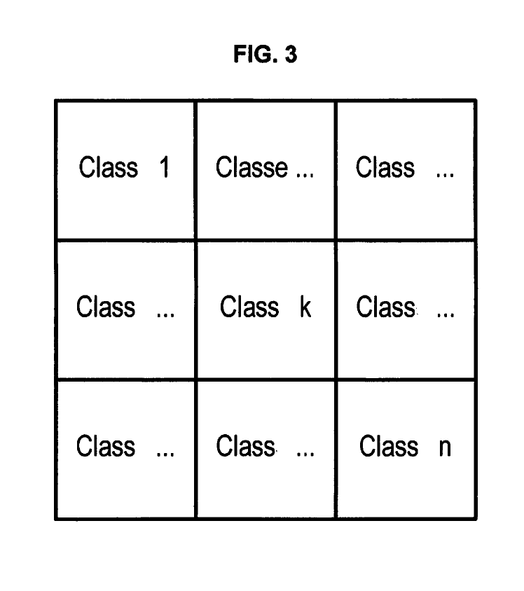

This clustering is applied to the whole set of past price vectors (learning data). These classes correspond to the most probable price evolution curves as a function of time (i.e. trends) that are named Ck, with 1<=k<=n. FIG. 3 shows a set of n classes.

It is necessary to normalize the trend information to make sure that the classification is properly performed. This normalization is done as a function of the price information of a given flight (minimum price, mean price, and median price for example).

Moreover, a price observation Pi taken randomly is always related to a set of explanatory variables. When dealing with flight tickets, for instance, such explanatory variables include the flight carrier, a number of date features (e.g., end of week, holidays, middle of week, etc.), the flight duration, the departure and arrival airports, etc.). The number and description of explanatory variables are predefined when designing the system, depending on the application, and, of course, may vary significantly from an application to another.

Thanks to the price data clustering, the explanatory variables are also gathered. For instance, a given flight of a given company at a given date will be allocated to a given cluster. The explanatory variables that are not used in the class discrimination are not considered here, because they do not provide useful information in the process. The other ones are, of course, considered. This gathering process according to explanatory variables can be optionally automated using methods such as a Correspondence Analysis (CA) (see https://en.wikipedia.org/wiki/Correspondence_analysis) or other comparable methods. The first step for the application of the CA method is the creation of the Contingency Matrix having in columns the explanatory variables, and in lines the indexes of the clusters (from the k-means classification for instance), each element of the matrix thus being the number of price evolutions belonging to a given cluster and corresponding to the given explanatory variable. The processing of the Contingency Matrix allows defining the links between explanatory variables and clusters.

Similarly to the classification applied to the (filtered) trend information Xi, a classification can be optionally implemented for the volatility Vi. In a preferred embodiment of the invention, a K-means clustering is used again, even if other automatic classification algorithms could fit here as well. This classification cannot directly be applied to the signal Vi, for which a least-square classification would have no sense. To perform the classification, the signal Vi is subdivided in several periods (typically, a dozen of days) and the variance of Vi is estimated on each period. Thus Vi is associated to a set {Di,1 . . . Di,p} where p is the number of periods and Di,p is the volatility variance over the period p. The classification is thus performed on these variance sets.

Similarly to the trends, the explanatory variables can optionally be clustered according to volatility (this cluster is most of the times different from the cluster obtained using the trends).

b) Considering a new observation, this new observation is partial by nature because the system is not aware of the whole price sets as a function of time (it is reminded here that the aim precisely is to predict the future behavior of the prices). From the explanatory variables of the observation, the observation may be assigned to a trend class or a set of trend classes. Similarly, the observation may optionally be assigned to a set of volatility classes. And given the features of these classes, it is possible to estimate the probability that the price reaches the lower threshold price (ceiling price) defined by the customer. Pi,k is defined as the probability that an element of the explanatory variable i belongs to the class k. Pi,k is estimated as follows:

$$Pi , k = \frac{Number of elements of explanatory variable i ∈ {S}_{k}}{Total number of elements of explanatory variable i}$$

$$with {\sum }_{k} {P}_{i , k} = 1$$

The way indicator SPI is computed will now be described in greater detail. For simplicity and clarity, the volatility will not be considered.

Let us consider an explanatory variable i (for instance, a given company), and that a limit price π, valid between the dates di and df (order initial date and order final date), has been provided. I_{di,df}(Cₖ≦π) is the indicator function such that I_{di,df}≦π)=1 if curve Ck goes through a value lower than t in the date range from di to df, and I_{di,df}≦π)=0 otherwise.

The success probability indicator SPI, for the price π, given the explanatory variable I, is expressed as:

$$SPI ( π \vert i ) = {\sum }_{k} {P}_{k , i} {I}_{di , df} ( Ck \leq π )$$

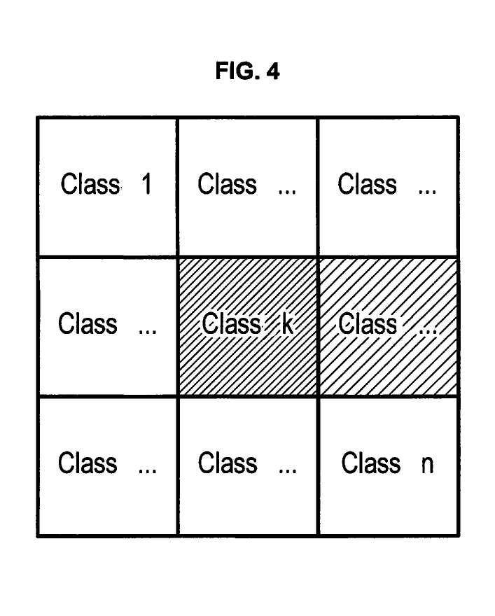

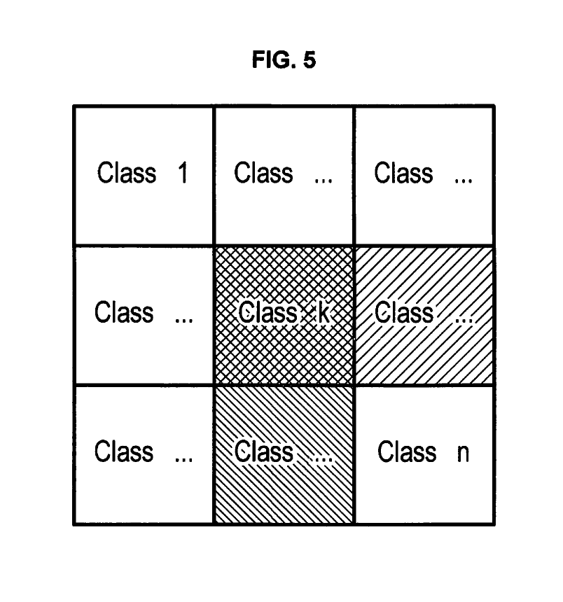

This formula can easily be generalized to the case of a larger number of explanatory variables. FIGS. 4 and 5 show the class identification by explanatory variables and their weightings according to the explanatory variable density.

Similarly, volatility may be taken into account by taking advantage of the link with the explanatory variables. Given the probability of belonging to a volatility class, the volatility variance may be estimated for each period. A centered Gaussian random variable which variance equals the estimated variance is added to Ck values: the SPI indicator is then computed as the probability that this value is lower than π. This division between the trend and the volatility is a particular feature of the invention. It expresses the fact that, depending on the performed observations, the price trend is a company's strategic choice, whereas the volatility reflects an occupancy rate feature. This feature is not linked to the trend. Thus, it is relevant to consider it separately.

Up to now, the success probability indicator is computed a priori, i.e. without using any current price observation data (the method only used explanatory variables).

c) Let us now assume that the system knows part of the price evolution, or needs to update the indicator calculation during the purchase order validity period that corresponds to the observation (in the present architecture, this observation comes from the option engine OE cache). This observation, even partially known, may be assigned to a certain cluster by computing a distance between the observation and the most probable price evolution patterns Ck (the trends). Depending on the amount of known information, the system combines an a priori allocation (via the explanatory variables) and an a priori distance allocation, weighted if possible. The weighting takes in consideration the amount of known information. This amount depends on the current date with respect to the beginning and ending dates of the order.

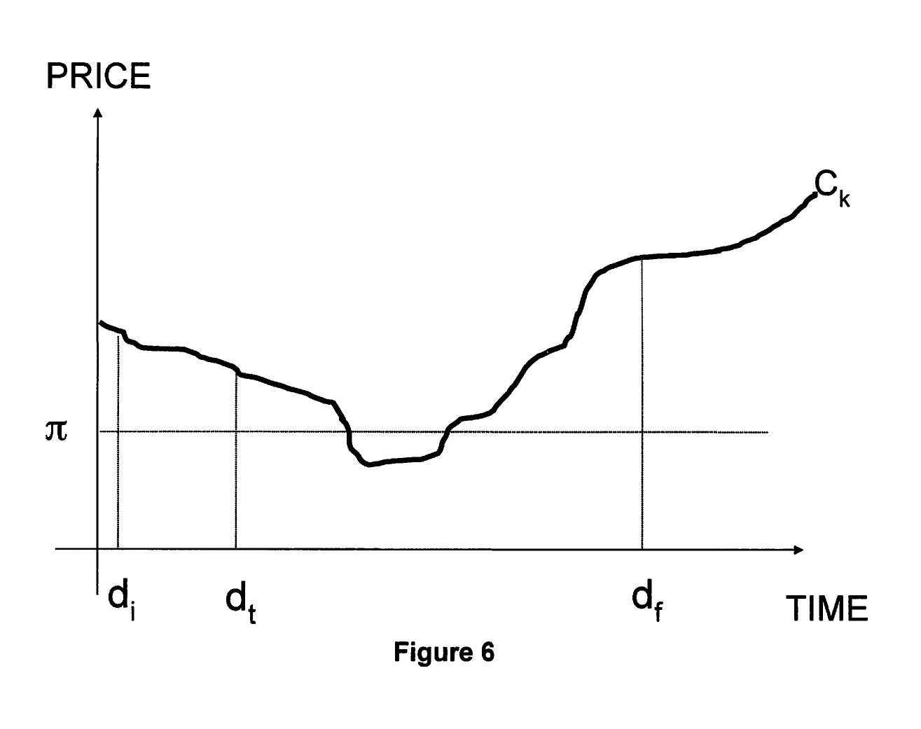

Let us consider the following hypothesis:
dt is the current date, di is the initial order date and df is the final order date, with di<dt<df (see FIG. 6);
π is the order price;
The observations Obs(di,dt) are classified in a given class Cj.

The success probability indicator SPI can then be computed by the following formula (1) (the volatility is not taken into account here for the sake of simplicity and clarity).

$$SPI ( π \vert i , Obs ( di , dt ) ) = \frac{dt - di}{df - di} {I}_{dt , df} ( {C}_{j} \leq π ) + \frac{df - dt}{df - di} {\sum }_{k} {P}_{k , i} {I}_{dt , df} ( {C}_{k} \leq π )$$

In the above formula, the adopted weighting is a function of the current date: when the current date is close to the initial date, the indicator SPI is computed by mainly referring to the explanatory variables; when the current date is close to the final date, the SPI is computed by mainly referring to the observations.

Finally, the recent price history may be used to regularly update (in the back-end) the cluster definition that may sometimes lead to a cluster adjustment.

This approach according to the invention offers several advantages:
the indicator SPI can be updated in near real-time: given the fact that the clusters are defined and updated with respect to the available databases, these clusters are capable of providing an indicator calculation each time that a purchase order is given by a buyer;
the indicator SPI is dynamic and converging: the computation of indicator SPI for a purchase order may be performed when a new purchase order is entered, and also may be regularly updated and refined as a function of the available price data; this update can be communicated to the buyer to help him taking his decision; this feature of the invention ensures a convergence of the probability indicator SPI toward a value that is even more significant when more actual price evolution data are collected for this order.
the system is adaptive: the cluster, performed by K-means or any other process, is regularly updated according to newly acquired data, which leads to a better cluster definition;
the system is robust, meaning that it can be executed with missing data without leading to meaningless clusters.

### 4. Purchase Order Presentation to Third Parties

In a preferred but non-limiting embodiment, the system comprises a feature that aims at presenting certain conditional purchase order lists to third parties, i.e. product or service sellers or retailers. These lists are made of customer database C-DB extracts. The aim of this presentation is to inform the sellers or retailers about the prices that the buyers are willing to pay to buy their products or services, and thus to encourage them to low their prices, immediately and automatically, to favor transactions.

More precisely, the purchase order details may be very useful to a seller, allowing him to modify (manually or automatically, depending on the presented list content) the prices of the excess product or service that he may have. Thus the seller is aware of the price he may sell a given amount of transactions, and an automatic program can set up the selling price to reach a given sales target, and possibly to fulfill all the considered active product or service orders. For instance, if we consider the case where the seller is aware of the fact that there is, for a given product, a purchase order with a ceiling price of 200 [symbol] whereas the current price is 220 [symbol] , an automatic program may be designed to occasionally decrease the price at 200 [symbol] to fulfill the order, whereas the price reduction to sell unsold products would have been higher without this order knowledge. Finally, the knowledge of the purchase order details may allow a seller to define his sale policy. According to the example of paragraph 2.3, the seller would favor the order 1 so as to sell at a higher unit price, depending on the product or service request he is the only one to dispose.

There are two modes to present the purchase order list: the push mode and the pull mode.

### 4.1 Pull-Mode Presentation on the Sales Platform

The sales platform allows to sellers or retailers, connected via a login/password combination, to have access to a dedicated area in which a seller or a retailer can search and check active purchase order details.

Each seller or retailer owns a dedicated area, and can only have access to the purchase orders related to his own products or services, and not his competitor's ones.

For instance, a sales manager of a airline company A has only access to the purchase orders of his own company's flights, and not the purchase orders of competitor's company B or C.

### 4.2 Push-Mode Presentation to Sellers or Retailers

The sales platform is capable of automatically providing purchase order details to various sellers or retailers. For instance, an order report is daily released for each seller, with a list and a detail of active orders concerning products or services provided by the considered seller.

### 4.3 Price Modification by Sellers and Retailers

Once the sellers have access to purchase order details, they may carry out certain transactions on their unsold or difficult-to-sell products or services, by decreasing their selling prices following two different mechanisms:

### a) “Public” Price Modification

After checking the purchase order prices for the products or services he offers, an online store can decrease the “public” price or “official” price for certain products or services that are difficult to sell. Given the fact that the sales platform regularly checks the “public” prices of the sellers and retailers, the considered products or services will be sold as soon as their selling prices decrease up to the purchase order prices.

For example, considering a airline company A that has difficulties in selling certain seats at 550 [symbol] for a given flight, after determining that there is a purchase order at a ceiling price of 500 [symbol] , the airline company A can low (manually or via a decision engine) its public price to 500 [symbol] . The platform will automatically buy the ticket at this price, because public prices are regularly checked.

### b) “Private” Price Modification

Certain sellers or retailers may have some difficulties to low their public price because all the buyers can have access to the public price decrease, and all the competitors can also decide to low their own prices, leading to an economically harmful price war.

Certain sellers may thus choose to sell their products or services at a lower price in certain distribution channels, thus applying a “private” price that is negotiated between the seller and its distributor.

After checking the purchase order price of his product or service, a seller can thus decrease the “private” price of certain products or services that are unsold on sales platform. If this decrease reached the purchase order ceiling price, the seller makes sure that the selling is processed immediately and automatically on the platform.

In the previous example, the airline company A agrees to decrease the “private” price to 500 [symbol] on the sales platform, whereas its “public” price remains at 550 [symbol] . Nevertheless, the sale is concluded at 500 [symbol] immediately and automatically.

It should be noted here that the purchase order lists can be provided to sellers for a counterpart (e.g. a financial counterpart) to the extent that it is able to increase the seller's profitability.

### 5. Advantages

The main advantages of the invention system are the following:

a) the system proceeds automatically and immediately: As soon as the seller agrees on the purchase order price, the transaction is concluded automatically and immediately on the sales platform;

b) the seller's agreement on the purchase order price is not public, and the price is considered as a “private” price; in this way, the “public” or “official” product or service price is not changed;

c) the system is profitable for the sellers; in fact, the sellers are able to know the price at which they may sell their unsold or difficult to sell products or services. Hence, they can minimize the decrease of their prices to simply satisfy the existing price orders.

### 6. Example of System Application for Flight Tickets Purchase

In the particular case of flight tickets purchase, the buyer can select precisely, besides the departure and arrival airports, the range of dates and the maximum price, a maximum number of flights to include in his order. The success probability indicator is computed and displayed on the customer's screen device in near real-time, to inform the buyer of the probability that at least one of his selected purchase order will succeed.

### 6.1 Class Definition

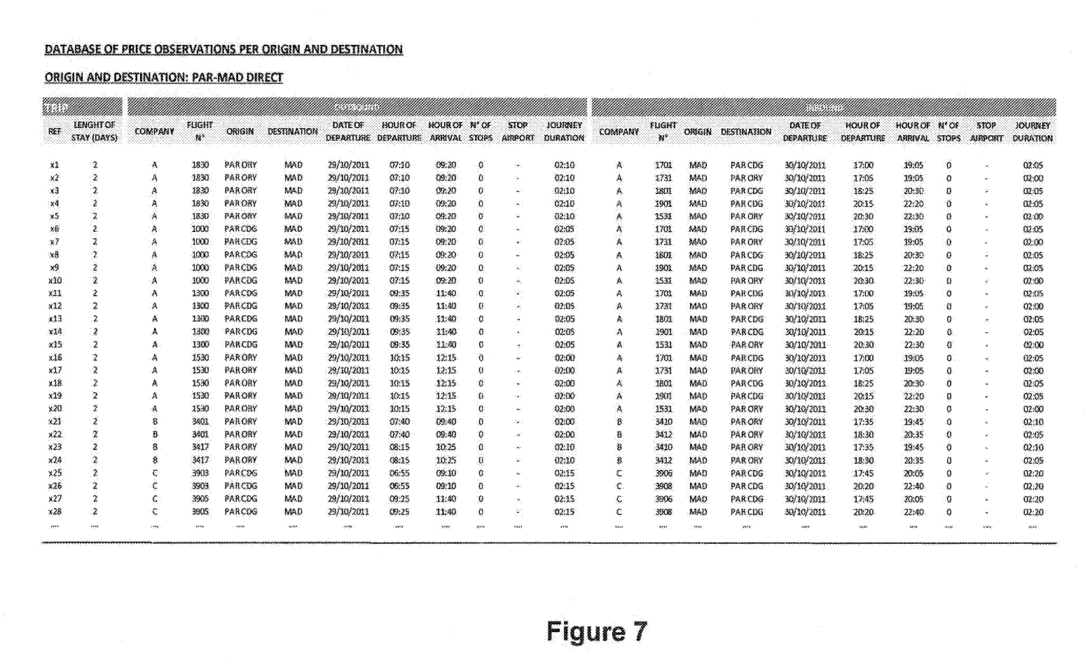

To implement the success probability indicator SPI, the first step of the process deals with defining the different classes for each route (i.e. flight between two cities), based on the past flight price history observation. The price observations are grouped in a specific database and are linked to explanatory variables (the carrier, the departure and arrival dates, the schedule) as shown in FIG. 7 for five observations x1, x2, x3, x4, x5 with their corresponding explanatory variables.

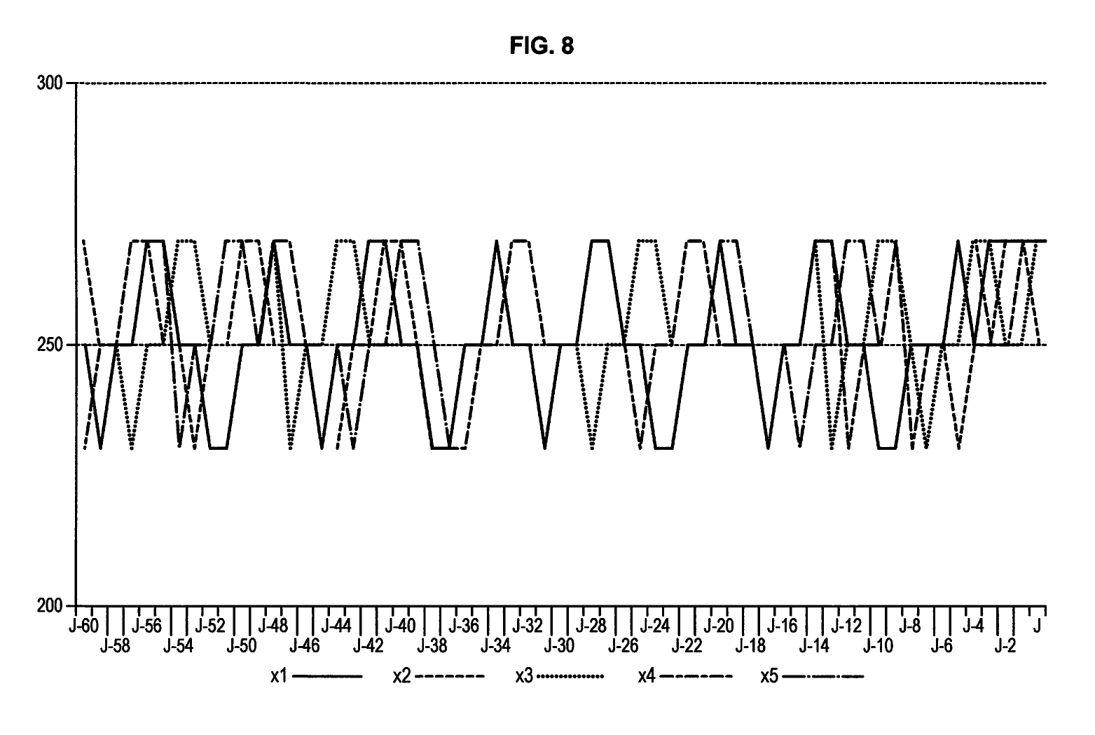

Each price observation is stored in a database and the five observations x1, x2, x3, x4 and x5 lead to the price curves as depicted in FIG. 8.

Given the price data vector equation Pi=Xi+Vi, the algorithm processes each price observation to determine the following features:
the price trend (x) that is defined by a low-pass filter; We can use for instance a moving average on the price over 3 to 5 days;
the price volatility (v) that is defined by several statistical values (in particular min-max fluctuation range, increase and decrease percentage, maximum increase and decrease, etc.) over short periods, for example 5 days.

Thus the algorithmic process assigns to each class a trend linked to a volatility for a set of explanatory variables specific to the considered class.

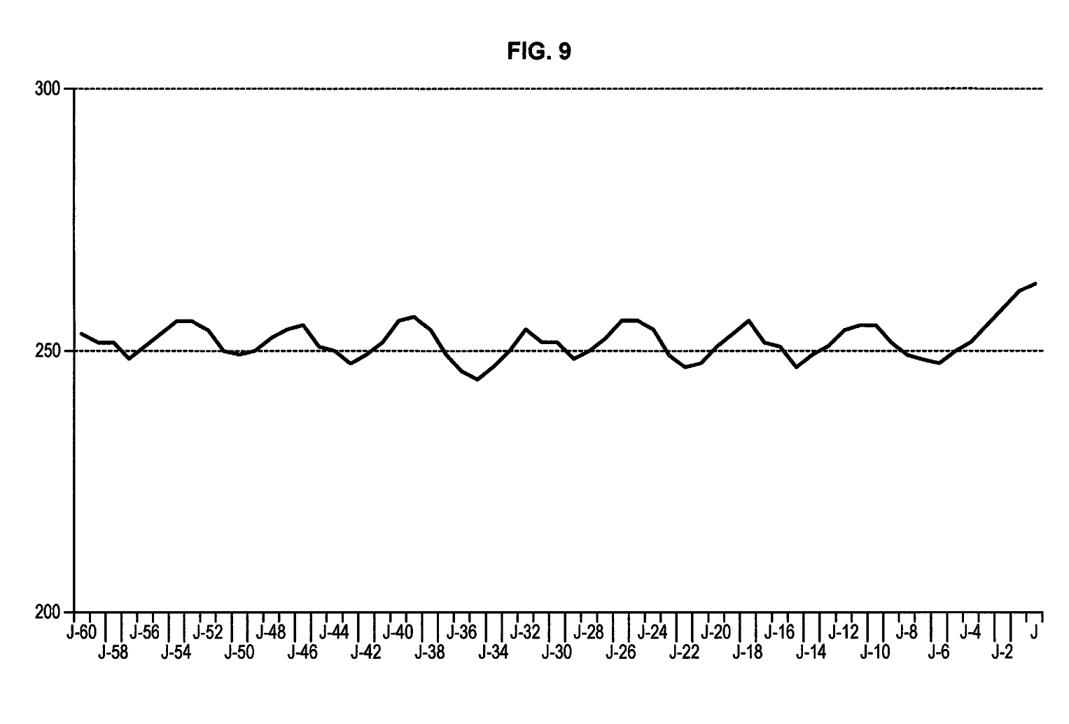

If we consider again the previous example, the price observations x1, x2, x3, x4 and x5 are assigned to a class S1, which trend is given in FIG. 9.

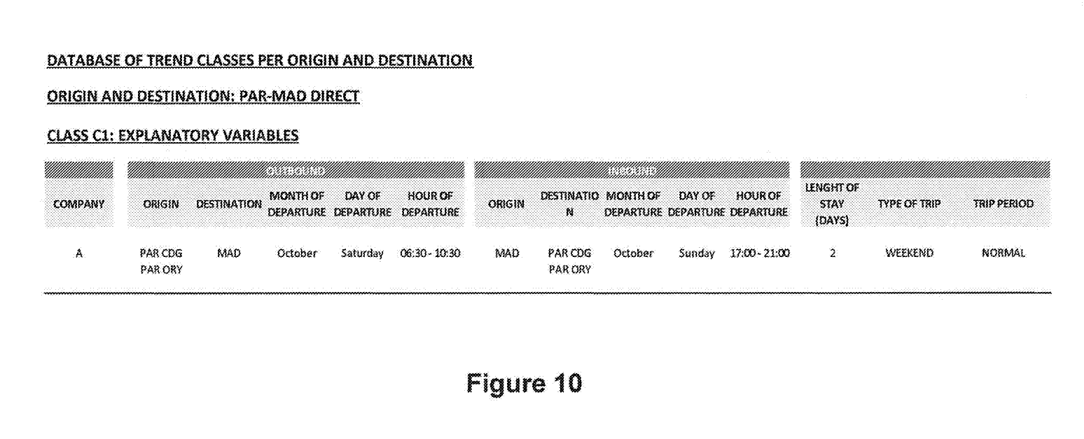

The explanatory variables linked to this class S1 gather the significant features for this class as shown, for example, in FIG. 10.

### 6.2 Flight Allocation to a Trend Class

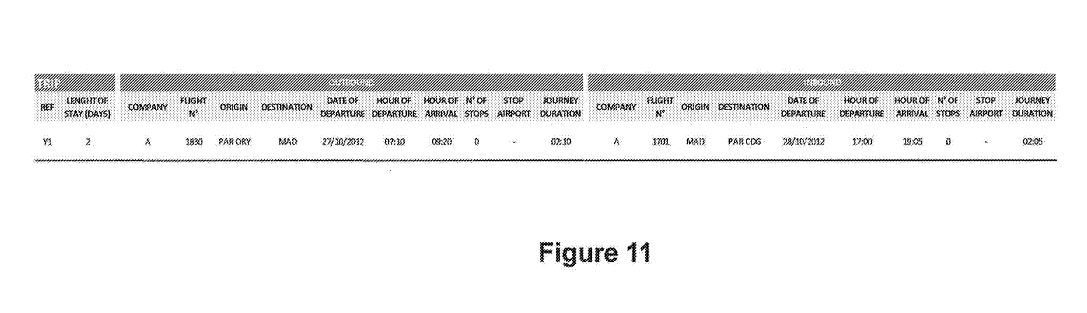

When a buyer selects certain flights and includes them in a purchase order, each flight is automatically identified by its main explanatory variables. For instance, a Paris-Madrid flight is defined as shown in FIG. 11.

In the class database for each flight, a program searches the trend classes the closest to the explanatory variables. It is reminded here that several classes may be found, and a weighting is then performed according to the density of the explanatory variable in each class found.

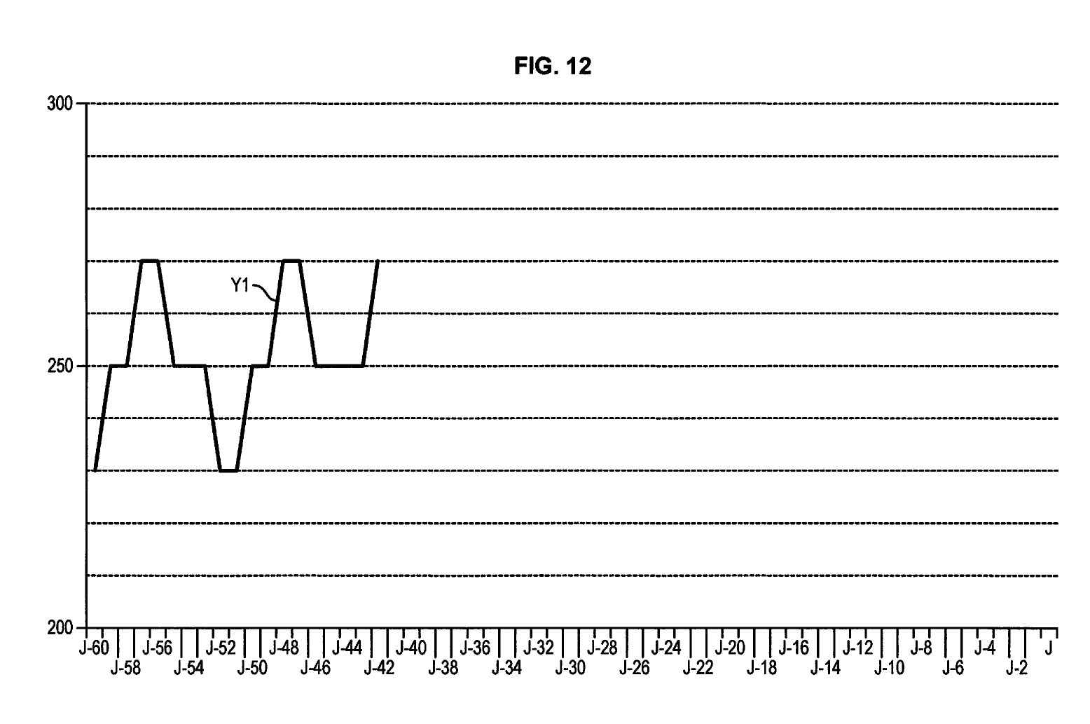

In the price history observations database, the recent past prices for the considered flight are extracted. If the data are sufficiently extensive, the past prices observation may be exploited. For instance, the recent price observation may be depicted as shown in FIG. 12.

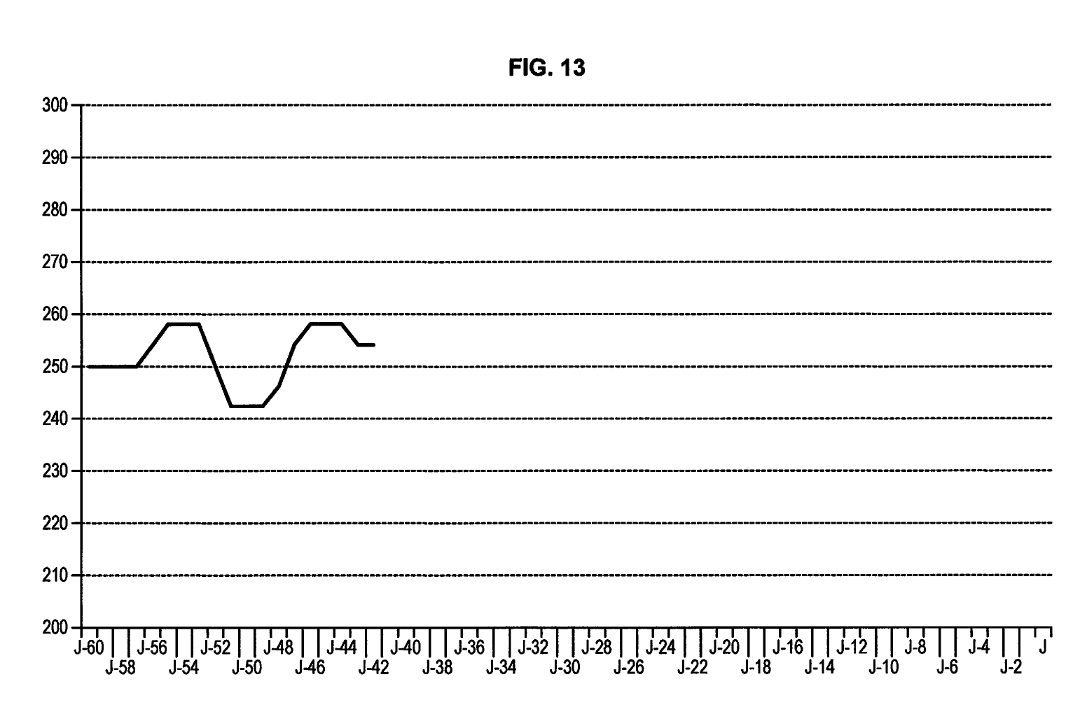

This observation is then processed to obtain the trend and the volatility as described previously. The trend is illustrated in FIG. 13.

In the present example, the class S1 is identified by the explanatory variables and by the recent prices observation trend and volatility.

The price evolution for the considered flight may then be predicted, and the success probability indicator SPI may be computed. In the present example, at D-42 (42 days) before departure, the current price is of 270 [symbol] . The prediction given by the S1 class is a horizontal trend associated to a relevant volatility in a price range between 230 [symbol] and 270 [symbol] . The success probability indicator is then high for a purchase order with a ceiling price higher than 230 [symbol] , and low for a purchase order with a ceiling price lower than 230 [symbol] .

### 7. Example of System Application for Hotel Nights Purchase

In the particular case of hotel stay purchase, the buyer can select precisely the hotels to be included in the purchase order, the dates, and a ceiling price. The success probability indicator is computed and displayed on the customer's screen device in near real-time, to inform the buyer of the probability that at least one of his selected purchase order will succeed.

7.1 CLASS definition

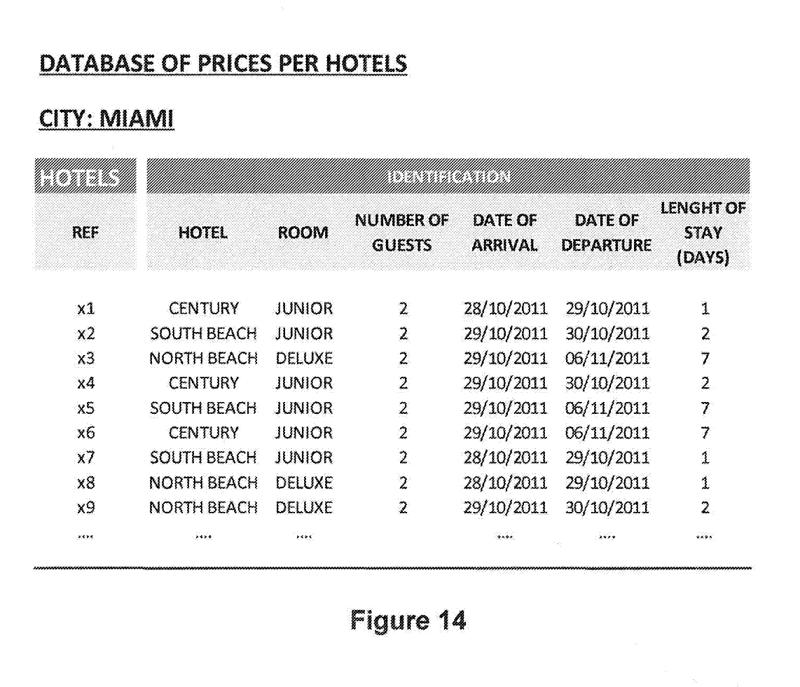

To implement the success probability indicator SPI, the first step of the process deals with defining the different classes for each city, based on the past price history observation. The price observations are grouped in a specific database and are linked to explanatory variables (the hotel reference, the arrival and departure dates, the room type, etc.) as shown in FIG. 14.

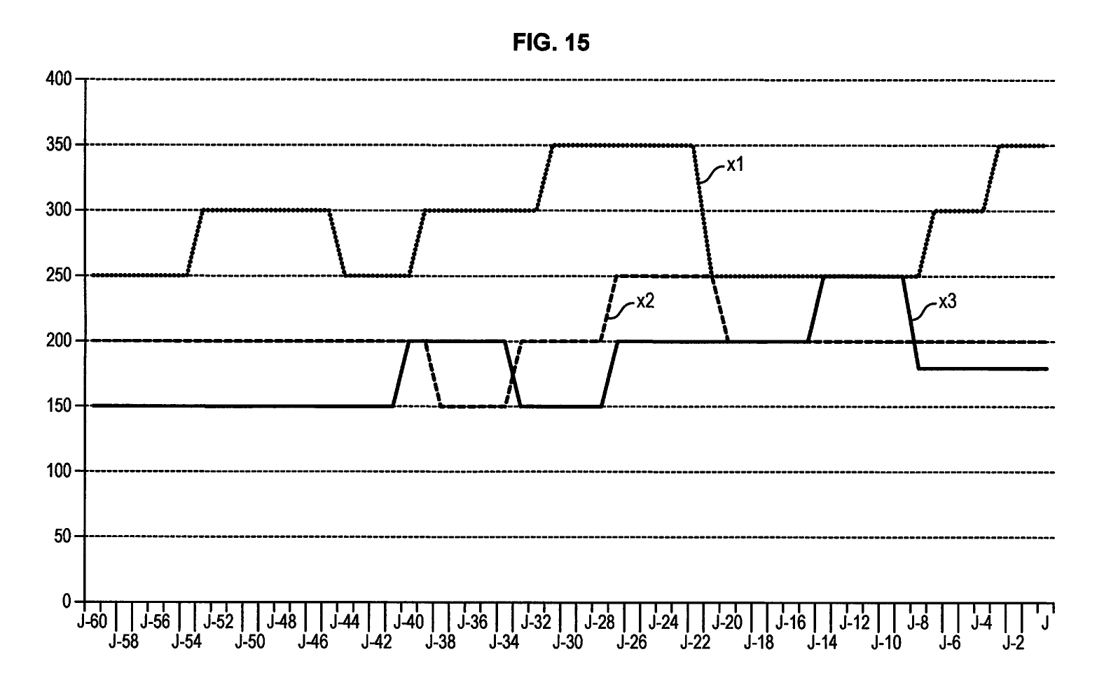

Each price observation is stored in a database and allows modeling a price curve, as depicted by way of example in FIG. 15.

The algorithmic process outputs a number of classes that are determined by the combination of a specific trend linked to a price volatility and to a set of explanatory variables.

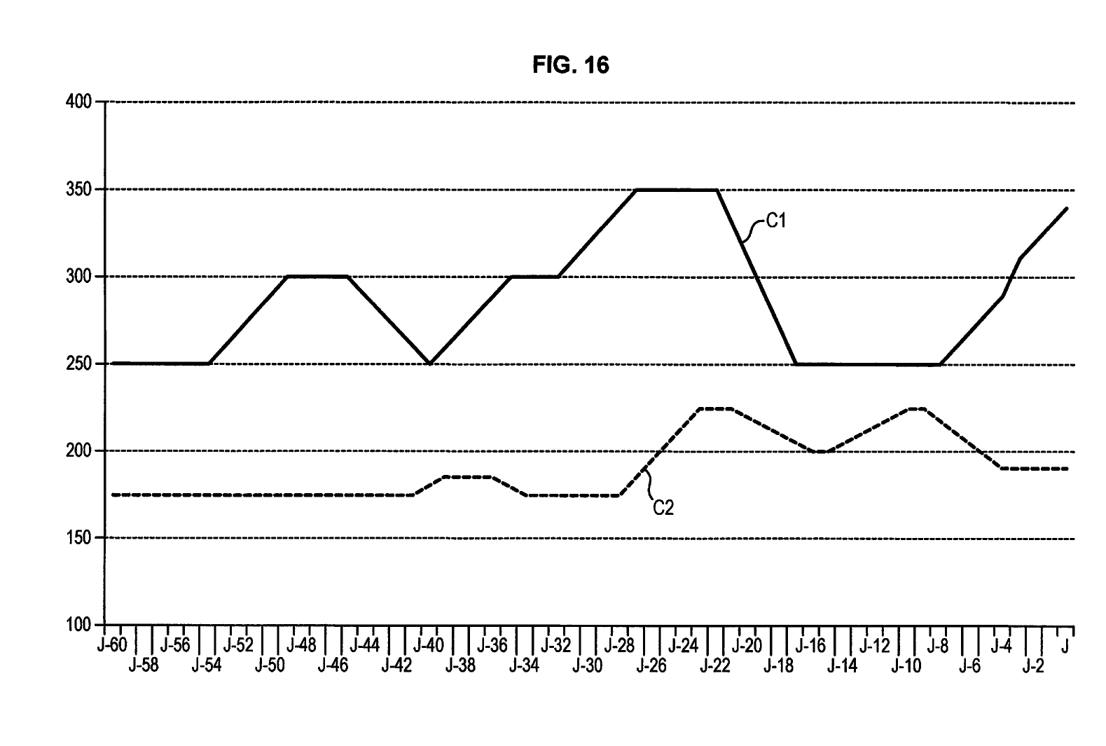

Considering again the aforementioned example, the price observations x1, x2, x3 are assigned to two classes S1 and S2, which trends are given in FIG. 16.

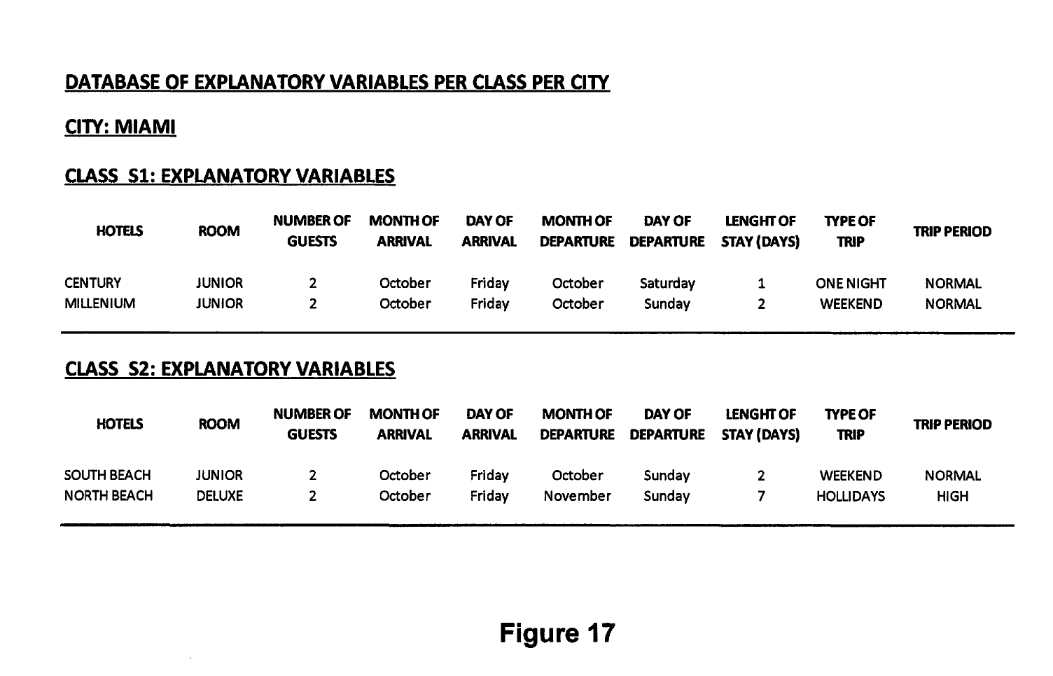

The explanatory variables linked to these classes S1 and S2 gather the significant features as shown, for example, in FIG. 17.

### 7.2 Purchase Order Allocation to a Class

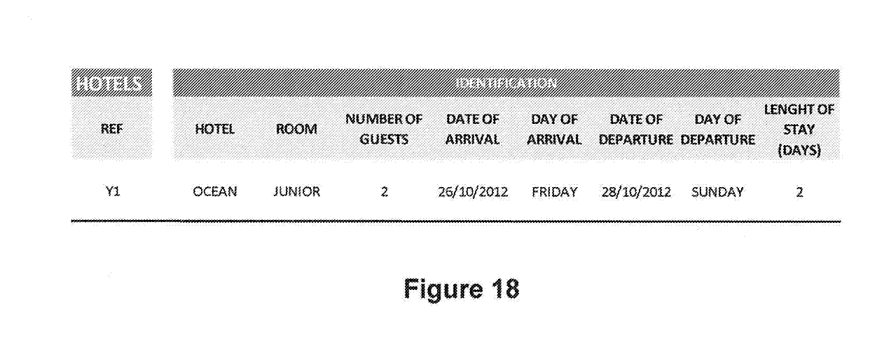

When a buyer selects a number of hotels and includes them in a purchase order, each hotel is automatically identified by its main explanatory variables. For instance, a hotel is defined as shown in FIG. 18.

In the class database for each city, a program searches the trend classes the closest to the explanatory variables. In this program, several classes may be found, which are sorted by priority (the first being the closest class). In this example, the class S2 is identified by its explanatory variables.

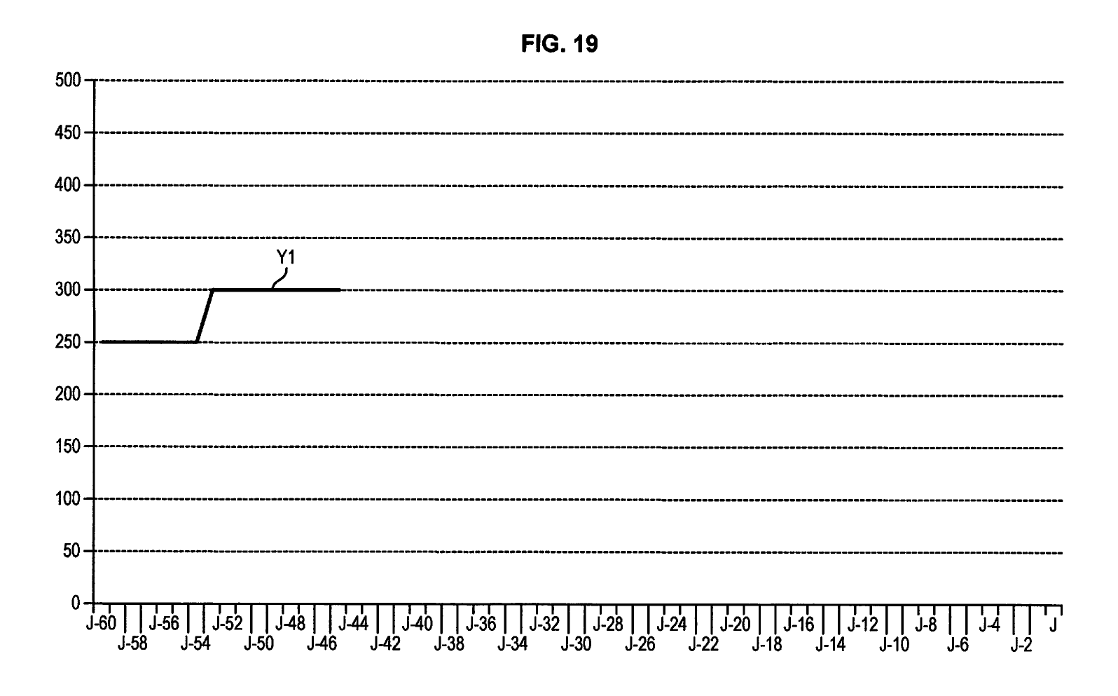

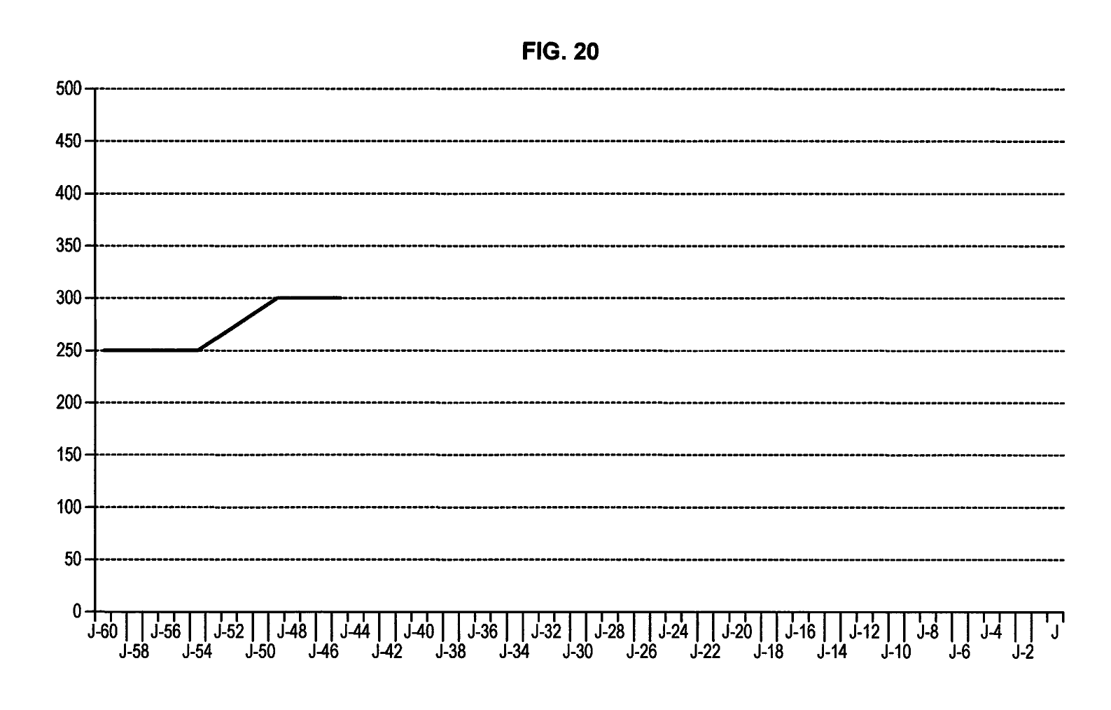

In the price history observations database, the recent past prices of the considered hotel are extracted. If the data are sufficiently extensive, the past prices observation may be exploited. For instance, the recent price observation may be depicted as shown in FIG. 19. This observation is then processed to obtain the trend illustrated in FIG. 20, and identified as the class S1. In this example, the recent prices observation lead to a class (S1) different from the one identified a priori by the explanatory variables (S2).

The success probability indicator SPI may be then computed by using the above formula that takes into account a weighting between the class identified by using the recent prices, and the one identified thanks to the explanatory variables, as follows:

$$SPI ( π \vert i , Obs ( di , dt ) ) = \frac{dt - di}{df - di} {I}_{dt , df} ( {C}_{j} \leq π ) + \frac{df - dt}{df - di} {\sum }_{k} {P}_{k , i} {I}_{dt , df} ( {C}_{k} \leq π )$$

The price evolution for the considered flight can then be predicted, and the success probability indicator SPI may be computed. In the present example, at D-45 before departure, the current price is of 300 [symbol] . The prediction given by the S1 class is a horizontal trend C1 associated to a relevant volatility in a price range between 250 [symbol] and 350 [symbol] . The prediction given by the S2 class is a horizontal trend C2 associated to a relevant volatility in a price range between 175 [symbol] and 225 [symbol] .

The success probability indicator is computed in the following way, considering a price observation over 15 days, and 60 days before departure:

$$SPI ( π \vert i , Obs ( di , dt ) ) = \frac{15}{60} {I}_{dt , df} ( {C}_{1} \leq π ) + \frac{45}{60} {\sum }_{k} {P}_{k , i} {I}_{dt , df} ( {C}_{2} \leq π )$$

Yet:

for π<250,

for π>250,

for π<175,

for π>175,

Therefore:

for π<175, IPS=0

for 175<π<250, IPS=15/60=25%

for π>250, IPS=100° A

Of course, the present invention is not limited to the embodiments described and illustrated herein, and the skilled person will be able to bring any improvements, variants, or modifications with his/her general knowledge in the art.

In particular:
the system may be applied not only to product or service purchase orders at ceiling prices, but also to product or service purchase orders at floor or minimum prices.
the general architecture may be different from the architecture described in the present description.

1. A computer system for managing limited counterpart transaction orders for products or services, in particular with a ceiling price, comprising:
a source of information indexing the available products or services and explanatory variables for these products or services, as well as time related counterpart information for these products or services,
an automatic classification engine adapted to gather products or services by classes of counterpart evolution, from historical counterpart data, and to attribute to each class a set of explanatory variables and an evolution behavior,
a client interface for inputting orders on given products and services defined by explanatory variable values, with a limit counterpart value,
a class allocation engine for allocating an inputted order to at least one evolution class depending on the explanatory variable values of the order, and
an indicator computation engine capable of computing a success probability indicator for an input order, combining the value of the limit counterpart value of the order with data of the evolution class(es) to which it is allocated,
means for providing to said client interface computed values of said success probability indicator, and
a matching engine to match offers and counterpart offers to convert orders into transactions when counterpart offers reach counterpart limit values of orders.

2. A system according to claim 1, wherein said indicator computation engine is capable, for a given order, of determining an initial estimated value of said success probability indicator from lookup tables containing success probability indicator values pre-determined from historical counterpart values for a number of limit counterpart values and a number of order validity time ranges, while waiting for current counterpart values from said source of information, and of computing a refined value of said success probability indicator after said current counterpart values have been received, both said initial estimated value and said refined value being successively provided to said user interface.

3. A system according to claim 2, further comprising a counterpart value caching engine for recent counterpart values, and said indicator computation engine is further capable, while waiting for current counterpart values from said source of information for a given order, of checking the contents of a cache memory handled by said caching engine to check for recent counterpart values corresponding to explanatory variable values of said order, and performing said computing with these values.

4. A system according to claim 1, wherein said indicator computation engine is capable of computing said success probability indicator from a weighted sum of probabilities, said probabilities being based on the density of explanatory variables associated to the classes and said weights being based on a relationship between the limit counterpart value and counterpart values in a validity time range of the order, derived from the respective classes.

5. A system according to claim 4, wherein said weights are Boolean values corresponding to the existence or not, within the validity time range in a class, of at least one counterpart value lower or equal to the limit counterpart value of the order.

6. A system according to claim 2, wherein the indicator computation engine is further adapted to perform a time-dependent weighting function between an indicator value computed from historical counterpart values and an indicator value computed from recently observed real counterpart values.

7. A system according to claim 6, wherein said time-dependent weighting function is performed on a periodic basis during the validity period of the order.

8. A system according to claim 1, wherein the evolution classes include trend classes and optional volatility classes.

9. A system according to claim 1, wherein the user interface is adapted to receive as input a new limit value for the counterpart during the validity period of the order, and wherein the indicator computing engine is adapted to compute a new value of the indicator in response to this input.

10. A system according to claim 1, further including priority order management device.

11. A system according to claim 10, wherein the priority order management device includes means for sequencing orders according to at least two criteria among information about the loyalty of the entities entering orders, information about the quantity of products or services requested in the orders, and information about counterpart limits.

12. A system according to claim 1, further including an aggregation engine for aggregating active orders on a product or service, and communication means between the aggregator engine and the seller's platform of the given product or service in order to allow an access to these aggregated orders.

13. A system according to claim 12, further including adjustment means for adjusting an offered counterpart for the given product or service in accordance with the values of the limit counterparts set in the aggregated orders.

14. A system according to claim 1, wherein said automatic classification engine comprises a K-means classification engine combined with a Correspondence Analysis (CA).

15. A computer-implemented method for managing limited counterpart transaction orders for products or services, in particular with a ceiling price, comprising the following steps:
at a server level, receiving an order from a client user interface on a given product or service, said order being defined by explanatory variable values and having a counterpart limit value,
at said server level, requesting from an external source of information current counterpart values for said given product or service,
using said explanatory variable values of the order, allocating said order to at least one among a plurality of counterpart value evolution classes, previously built from historical counterpart values, wherein each class is associated to a set of explanatory variables and defines an evolution behavior,
computing a success probability indicator value for said input order from the counterpart limit value and the allocated evolution class(es) information,
providing said success probability indicator value to said client interface for display,
performing a matching test on said order and counterpart offers to convert said order into a transactions when a counterpart offer reaches said counterpart limit value.

16. A method according to claim 15, wherein said computing step comprises determining an initial estimated value of said success probability indicator from lookup tables containing success probability indicator values pre-determined from historical counterpart values for a number of limit counterpart values and a number of order validity time ranges, while waiting for current counterpart values from said source of information, and computing a refined value of said success probability indicator after said current counterpart values have been received, both said initial estimated value and said refined value being successively provided to said user interface.

17. A method according to claim 16, further comprising a step of caching recent counterpart values, and wherein said computing step comprises, while waiting for current counterpart values from said source of information for a given order, checking the cached recent counterpart values corresponding to explanatory variable values of said order, and performing said computing with these values.

18. A method according to claim 15, wherein said computing step comprises computing said success probability indicator from a weighted sum of probabilities, said probabilities being based on the density of explanatory variables associated to the classes and said weights being based on a relationship between the limit counterpart value and counterpart values in a validity time range of the order, derived from the respective classes.

19. A method according to claim 18, wherein said weights are Boolean values corresponding to the existence or not, within the validity time range in a class, of at least one counterpart value lower or equal to the limit counterpart value of the order.

20. A method according to claim 16, wherein said computing step comprises performing a time-dependent weighting function between an indicator value computed from historical counterpart values and an indicator value computed from recently observed real counterpart values.

21. A method according to claim 20, wherein said time-dependent weighting function is performed on a periodic basis during the validity period of the order.

22. A method according to claim 15, wherein the evolution classes include trend classes and optional volatility classes.

23. A method according to claim 15, further comprising:
receiving as input at the user interface a new limit value for the counterpart during the validity period of the order, and
computing a new value of the indicator in response to this input.

24. A method according to claim 15, further comprising a step of subjecting the conversion into a transaction to a prioritization according to at least two criteria among information about the loyalty of the entities having entered active orders, information about the quantity of products or services requested in active orders, and information about counterpart limits in the active orders.
